(19) United States
(12) Patent Application Publication
(10) Pub. No.: US 2016/0212984 A1
(43) Pub. Date: Jul. 28, 2016

(54) INSECT TRAP

(71) Applicant: GOLDWIN HOLDINGS LIMITED, Wan Chai, Hong Kong (CN)

(72) Inventors: Xiangqian FANG, Changsha, Hunan (CN); Shiann Hsiung LIU, Pleasant Hill, CA (US)

(21) Appl. No.: 15/024,922

(22) PCT Filed: Apr. 25, 2014
(86) PCT No.: PCT/CN2014/076282

§ 371 Date: Mar. 25, 2016

(30) Foreign Application Priority Data
Sep. 25, 2013 (CN) 201310451010.2

(51) Int. Cl. A01M 1/10; A01M 1/08; A01M 1/02

(52) U.S. Cl. CPC A01M 1/106; A01M 1/023; A01M 1/08

(57) ABSTRACT

The present invention provides an insect trap. The insect trap comprises a housing including an inlet opening and a outlet opening; a fan device disposed within the housing, for generating an air flow passing through the housing to draw in insects from the inlet opening; a collecting device attached to the outlet opening of the housing, so as to collect the insects being drawn into the housing; and an attractant holder and a light emitting device for attracting insects, wherein the attractant holder is disposed in the vicinity of the inlet opening so as to emit volatiles of attractant in the upstream of the inlet opening along an flowing direction of the air flow and toward outside of the housing. The insect trap provided by the present invention is compact and simple in structure, and can trap the insects effectively.

### CROSS-REFERENCE TO A RELATED APPLICATION AND PRIORITY CLAIM

This application claims the benefit under 35 U.S.C. §371 to International Application Number PCT/CN2014/076282 filed on 25 Apr. 2014 which claims the priority of Chinese Patent Application No. 201310451010.2 filed on 25 Sep. 2013 to which priority is also claimed by the present application. The entire disclosures of said applications are incorporated by reference herein for all purposes.

### FIELD

The present invention relates to an insect trap. Specifically, the present invention relates to an insect trap attracting and trapping the insects, such as a mosquito and a drosophila, by a light source and/or an attractant.

### BACKGROUND

Every year over a million people worldwide die from mosquito-born diseases such as Malaria, Dengue, Encephalitis, and West Nile Virus Infection. In addition to the transmission of the diseases, the bites of mosquitoes may make people uncomfortable and interrupt their sleep. Using chemical insecticides to kill mosquitoes has detrimental health effects and damaging environmental repercussions. Mosquito coils only can drive the mosquitoes away temporarily and cannot actually reduce their quantity.

It is known a mosquito trap which traps the mosquitoes via a light source of particular wavelength. However, related study (referring to Document 1) shows that only about 3%-4% of the insects killed by a mosquito trap which attracts the mosquitoes via UV light are biting female mosquitoes, and about 96%-97% are not biting mosquitoes. Thus, the effect of capturing mosquitoes merely depending on the light source is not desirable.

It is well known that hematophagous insects are attracted to their hosts by sensing the carbon dioxide distributed by the hosts into the air. Therefore, the researchers have been studying and developing the mosquito trap which traps the mosquitoes using carbon dioxide. It is known a commercially available photocatalyst mosquito trap, which adds a titanium dioxide coating inside the mosquito trap. It is asserted that the titanium dioxide can react with ultraviolet light to produce oxygen anions, which can then chemically react with planktonic microorganism in the air and thus produce carbon dioxide and water. The effect of trapping mosquitoes can be enhanced via the attraction of the ultraviolet light together with the carbon dioxide. However, so far there is no evidence showing that the carbon dioxide generated by the photocatalyst mosquito trap is concentrated enough to be detectable, and the effect of trapping mosquitoes of this photocatalyst mosquito trap has been proved to be substantially the same as that of mosquito trap merely having a light source.

Further, U.S. Pat. No. 6,145,243 of Wigton etc. discloses a counter-flow type insect trapping device which attracts mosquitoes via carbon dioxide. The disclosed insect trapping device uses the carbon dioxide, produced by combusting and catalyzing the fuels such as alkane, as attractant. The carbon dioxide is exhausted through an exhaust pipe, and the mosquitoes, which are attracted by the carbon dioxide to the area near the outlet of the exhaust pipe, is drawn in through a suction pipe that concentrically surrounds the exhaust pipe. Although the insect trapping device uses carbon dioxide as attractant to attract insects, the layout of the counter-flow type makes the structure very complicated. Moreover, since the carbon dioxide is diluted with the exhaustion of the air flow, it is required to produce quite a lot of carbon dioxide inside the device in order that the concentration of the diluted carbon dioxide in the outlet opening of the exhaust pipe reaches an attractive level. Furthermore, due to a large amount of fuel needed and a large amount of carbon dioxide produced by the device, and a lager size of the device, this kind of device is normally used outdoors only. In addition, the insect trapping device is normally produced via a complex process with a high cost, which restricts its popularity.

Thus, there is a need for an insect trap which is able to capture mosquitoes effectively, has a simple structure and a smaller size, and is suitable for indoor use.

### REFERENCE LIST

Non-patent publication 1: Nasci, R S, C W. Harris and C K Porter. 1983. Failure of an insect electrocuting device to reduce mosquito biting. Mosquito News. 43:180-184
Patent publication 2: U.S. Pat. No. 6,145,243

### SUMMARY

The invention provides an insect trap of small size, simple structure, and high efficiency which can overcome the above disadvantages in the prior devices.

The invention provides an insect trap comprising a housing including an inlet opening and an outlet opening; a fan device disposed within the housing, for generating an air flow passing through the housing from the inlet opening to the outlet opening to draw in insects from the inlet opening; and an attractant holder including a cavity for disposing an attractant and an opening for emitting volatiles of the attractant, wherein, the attractant holder is disposed so that the opening of the attractant holder is in the vicinity of the inlet opening, and is located upstream of the inlet opening along an flowing direction of the air flow and is oriented toward outside of the housing.

According to one aspect of the present invention, the housing may be formed as a hollow cylinder, the fan device may be provided within a hollow portion of the cylinder, the inlet and the outlet openings may be communicated with the hollow portion, and the position and orientation of the inlet and outlet openings in the cylinder may be provided so that the air flow discharged from the outlet opening causes no turbulence near the inlet opening. In addition, the inlet opening may be located at one end of the cylinder, and the outlet opening may be located at the other end of the cylinder. Furthermore, the inlet opening may be provided on an end surface at the one end of the cylinder. The housing may further comprise an inlet cover which is formed as the one end of the cylinder, and the inlet cover may comprise at least one opening for forming the inlet opening. The inlet opening may be provided on a side surface at the one end of the cylinder. The end surface of the inlet cover may be formed with grilles so as to form the inlet opening, and the attractant holder may be mounted to a center of the end surface which is aligned with a center of the fan device.

According to a further aspect of the present invention, the attractant holder may be detachably mounted to the housing. The attractant holder may be provided adjacent the inlet opening. The attractant holder may be mounted within the housing. The attractant holder may be mounted to the end surface at the one end of the cylinder and the attractant holder may also be mounted to a center of the end surface at the one end of the cylinder. The insect trap may comprise a plurality of said attractant holders, and the plurality of the attractant holders may be arranged equidistantly.

According to a further aspect of the present invention, the collecting device may be a vent bag or a body including a ventilated net, and the collecting holder may be detachably mounted to the housing. The collecting holder may comprise a valve, the valve may be opened when the collecting device is connected with the housing so that the insects drawn in through the inlet opening can pass through the valve and enter into the collecting device, and the valve may be closed when the collecting device is removed from the housing so as to prevent the insects inside the collecting device from getting away from the collecting device trough the valve. The housing further comprises an ejector pin, and the collecting device may further comprise a spring device. The valve may be rotatably connected to the collecting device via a hinge, and the spring device may urge the valve in a direction to close the valve. When the collecting device is mounted to the housing, the ejector pin may force the valve to rotate in an opening direction.

According to a further aspect of the present invention, the attractant may be one of or a combination of at least two of: pheromone, lactic acid, agorophyl alcohol, compound that can be decomposed to release ammonia gas, and compound that can be decomposed to release carbon dioxide. The compound that can be decomposed to release ammonia gas may comprise ammonium bicarbonate. The compound that can be decomposed to release carbon dioxide may comprise ammonium bicarbonate. The aperture of the opening of the attractant holder may be arranged so that the volatiles of the attractant run out of the openings at the rate between 0.1 mg/hour and 10 mg/hour.

According to a further aspect of the present invention, the insect trap may further comprise a light emitting device for emitting lights attracting insects. The light emitting device may include at least one of a light emitting diode, a fluorescent lamp, or a cold cathode ray tube.

The light emitting device may be a light emitting diode emitting UV. The power of the light emitting diode may be in the range of 0.01 w to 0.1 w. The power of the light emitting diode may be 0.06 w. The insect trap may further comprise a plurality of said light emitting diode. The light emitting device may include a plurality of light emitting diodes mounted to the inlet cover, and the light emitting diode can emit UV.

According to a further aspect of the present invention, the insects may comprise a mosquito or a drosophila.

With the insect trap according to the embodiments of the present invention, the fan device generates an air flow passing through the housing from the inlet opening to the outlet opening, so as to draw in the mosquitoes from the inlet opening. As compared with the counter-flow type insect trap, the insect trap of the present invention generates the air flow merely in a single direction at the inlet opening, thus, it is possible to capture the mosquitoes with a simpler structure and causes no turbulence of the air flow, and it is easy for the concentration of volatiles of attractant to satisfy the requirements of attracting mosquitoes. Further, in the insect trap of the present invention, the openings of the attractant holders are disposed near the inlet opening of the housing, and located at the upstream of the inlet opening along the flowing direction of the air flow and toward the outside of the housing. With such a configuration, the concentration of the volatiles of attractant can be kept highest in the vicinity of the inlet opening compared with other positions. Although part of the volatiles may enter into the inlet opening and flow toward the outlet opening in the downstream with the air flow, these volatiles are rapidly diluted by the air flow. As a result, compared with the outlet opening, the mosquitoes are more likely to be attracted by the volatiles near the inlet opening, and thus the structure of the present invention can significantly improve the capture efficiency of mosquitoes.

Further, according to the present invention, the attractant holder is arranged on the end surface of the inlet end of the housing, the end surface is formed with grilles, and the center of the end surface is aligned with the center of the fan device. In this case, the pressure in front of the attractant holders is relatively small, and thus a negative pressure is generated around the attractant holder due to the air flow generated by the fan device. This pressure distribution contributes to appropriately increase the amount of the volatiles from the attractant in the attractant holder, and can also extend the residence time of the volatiles of attractant remaining near the openings of the attractant holder, and thus, the concentration of the volatiles of attractant near the openings of the attractant holder (that is, near the upstream of the inlet opening) can be increased.

Further, according to the present invention, the collecting device is detachably mounted to the housing, and is opened and closed in connection with being mounted to and removed from the housing. With such a configuration, the collecting device can be removed conveniently, and prevent mosquitoes from escaping when being removed.

Further, the insect trap according to the present invention has the advantages of simple structure, small size, and low manufacturing cost. Also, the insect trap uses non-toxic attractant without pollution to the environment and thus is environmentally friendly. Moreover, the insect trap of the present invention is suitable for indoor use.

### BRIEF DESCRIPTION OF THE DRAWINGS

The above and other objects, features and advantages of the present invention will be better understood from the description of the example embodiment that follows with reference to the accompanying drawings, wherein the same reference numbers refer to the same elements, in which:

FIG. 1 is an overall structure view of the insect trap according to the first embodiment of the present invention;

FIG. 2 is an exploded structure view of the insect trap according to the first embodiment of the present invention;

FIG. 3 is a schematic view of a mounting structure of the attractant holder of the insect trap according to the first embodiment of the present invention;

FIG. 4 is a schematic view showing the relevant structure when the collecting device is removed from and attached to the housing according to the first embodiment of the present invention, wherein part A of FIG. 4 shows the state of the collecting device removed from the housing, and part B of FIG. 4 shows the state of the collecting device mounted to the housing;

FIG. 5 is a schematic view of the insect trap according to the first embodiment of the present invention in an operating status;

FIG. 6 is a schematic view showing in part A the insect trap and the position of the attractant holder according to the first embodiment of the present invention, showing in part B the insect trap and different effective positions of the attractant holder according to the first embodiment of the present invention; and

FIG. 7 is a schematic view showing in part A the insect trap and the position of the attractant holder according to the second embodiment of the present invention, showing in parts A-C the insect trap and different effective positions of the attractant holder according to the second embodiment of the present invention.

### DETAILED DESCRIPTION

The present invention will be described referring to the accompanying drawings. The relationship and functions of various elements can be understood better according to the following specific description. However, the embodiments described below are merely illustrated as examples, and the present invention is not limited to the embodiments shown in the accompanying drawings. In addition, the structure and function of the embodiments of the present invention are described by use of the mosquito as an example.

### The First Embodiment

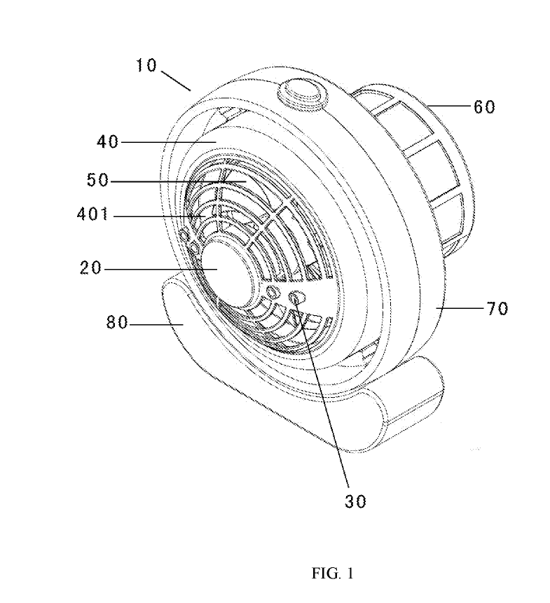

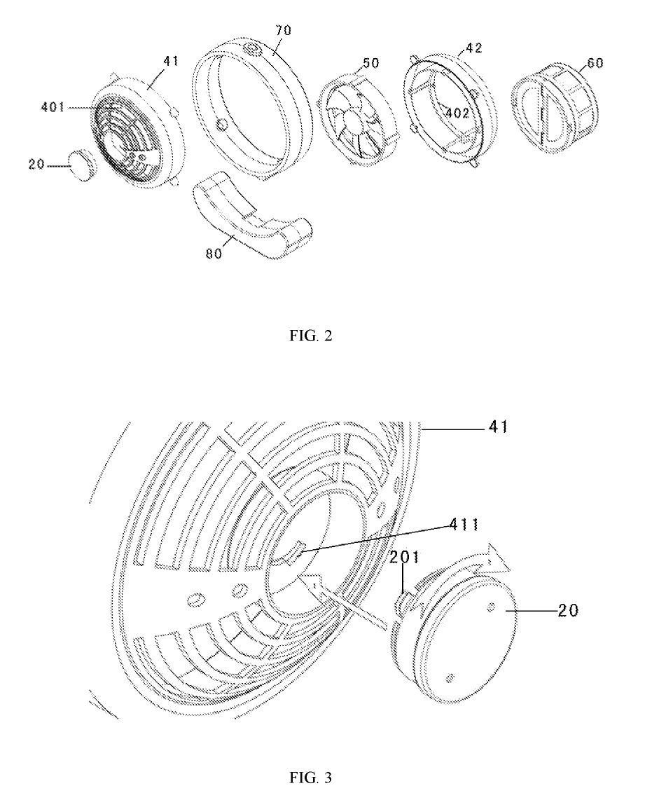

FIG. 1 shows an overall structural view of an inset trap 10 according to the first embodiment of the present invention. FIG. 2 shows an exploded structure view of the insect trap 10 according to the first embodiment of the present invention. As shown in FIG. 1 and FIG. 2, the insect trap 10 includes an attractant holder 20, a light emitting device 30, a housing 40, a fan device 50 and a collecting device 60. The attractant holder 20 is used to contain attractant and attract the mosquitoes by emitting volatile of the attractant. The light emitting device 30 is used to attract the mosquitoes by emitting light. The housing 40 is formed as a hollow cylinder with a substantially circular cross section. The housing 40 includes an inlet opening 401 provided on one end (which is referred as “an inlet end” hereinafter) thereof and an outlet opening 402 provided on the other end. The inlet opening 401 and the outlet opening 402 are communicated with the hollow portion of the cylinder. The fan device 50 is disposed in said hollow portion of the housing 40, and is used for generating an air flow in a direction from the inlet opening 401 to the outlet opening 402 through the housing 40, so as to draw the mosquitoes into the inlet opening 401. The collecting device 60 is connected to the outlet opening 402 of the housing 40 for collecting the mosquitoes drawn into the housing and discharge the air flow driven by the fan device 50.

Referring to FIG. 2 again, the housing 40 of the insect trap 10 includes an inlet cover 41, which is formed as the inlet end, and an outlet cover 42. The end surface of the inlet cover 41 is formed with grilles, and the openings between the grilles are used as the inlet opening 401. The inlet cover 41 and outlet cover 42 are fixed to an outer ring 70, which is further fixed to a base 80, so as to form the housing 40.

The attractant holder 20 has one or more cavities for containing the attractant and one or more openings for emitting the volatiles of attractant, wherein different cavity may be used to contain the same or different types of attractant. The attractant holder 20 is detachably mounted to the housing 40, so that the openings of the attractant holder 20 are located at the upstream of the inlet opening 401 along the flowing direction of the air flow and oriented toward the outside of the housing 40, in the vicinity of the inlet opening 401. Specifically, as shown in FIG. 1 and FIG. 2, the attractant holder 20 is mounted to a center of an end surface of the inlet cover 41 (i.e., the end surface of the inlet end of the housing 40), which is aligned with a center of the fan device 50. The attractant holder 20 emits the volatiles of attractant via the openings to attract the mosquitoes toward the vicinity of the inlet opening 401, so that the air flow generated by the fan device 50 can draw the mosquitoes into the housing 40 through the inlet opening 401.

FIG. 3 shows a schematic view of a connecting structure between the attractant holder and the housing according to the first embodiment of the present invention. The attractant holder 20 is detachably mounted to the housing 40 via the connecting structure shown in FIG. 3. As shown in FIG. 3, the attractant holder 20 is formed in a cylindrical shape, with the openings provided in an end surface of the attractant holder 20 oriented toward the outside of the housing 40. The attractant holder 20 is provided with a tenon 201 in the other end surface opposite to the end surface on the side of the openings. The inlet cover 401 is formed with an indentation in the center of the end surface on the end provided with the inlet openings 401, and a mortise 411 is provided on the bottom of the indentation, and can be matchably connected with the tenon 201 on the attractant holder 20. The attractant holder 20 can be fixed to the inlet cover 41 of the housing 40 by snapping the tenon 201 of the attractant holder 20 into the mortise 411 on the inlet cover 41 of the housing 40 and rotating the attractant holder 20, and the attractant holder 20 can be removed from the inlet cover 41 of the housing 40 by operating reversely.

In this embodiment, the attractant within the attractant holder 20 may include substances that can attract the mosquitoes, such as alcohol, acid, and ammonia. For example, the attractant may be one of the following substances or a combination of: pheromone, lactic acid, agorophyl alcohol, compound that can be decomposed to release ammonia gas (such as ammonium bicarbonate), and compound that can be decomposed to release carbon dioxide (such as ammonium bicarbonate).

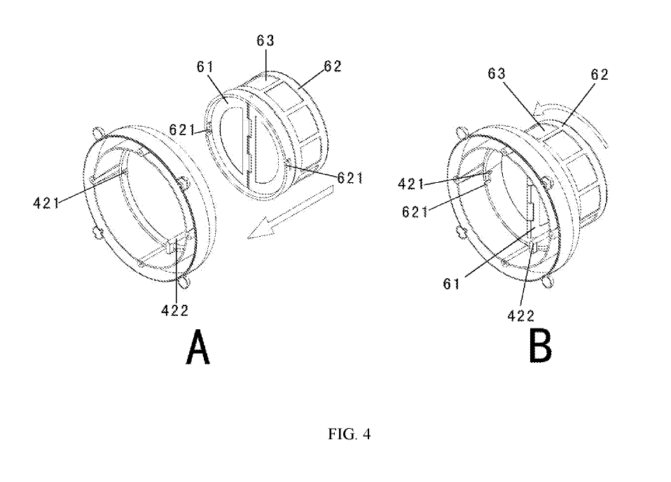

Next, the collecting device 60 of the insect trap 10 according to the first embodiment of the present invention will be described in detail by referring to FIG. 4. The collecting device 60 according to the present invention is detachably attached to the housing 40. Part A of FIG. 4 shows the state of the collecting device 60 of the insect trap 10 according to the first embodiment of the present invention removed from the housing 40 (the outlet cover 42), and part B of FIG. 4 shows the state of the collecting device 60 of the insect trap 10 according to the first embodiment of the present invention attached to the housing 40 (the outlet cover 42). The collecting 60 includes a valve 61. The valve 61 is opened when the collecting device 60 is attached to the housing 40, so that the mosquitoes drawn in through the inlet opening 401 can enter into the collecting device 60, and the valve 60 is closed when the collecting device 60 is removed from the housing 40, so as to prevent the mosquitoes within the collecting device 60 from escaping via the valve 61. Additionally, the collecting device 60 further includes a body 62 and a ventilated net 63. The mosquitoes are collected inside the body 62 and ventilated net 63, and the air flow generated by the fan device 50 exits through meshes of the ventilated net 63.

Next, the relating structure for the collecting device 60 to be mounted to and removed from the housing 40 is described in detail. As shown in part A of FIG. 4, the collecting device 60 is formed with a slot 621 on an edge of the body 62, and the slot 621 can matchably connected with a tenon 421 provided on an edge of the outlet cover 42 of the housing 40. The collecting device 60 can be fixed to the outlet cover 42 of the housing 40 by inserting the tenon 421 on the outlet cover 42 of the housing 40 into the slot 621 of the collecting device 60 as shown in part A of FIG. 4 and rotating the collecting device 60 as shown in part B of FIG. 4. By operating reversely, the collecting device 60 can be removed from the outlet cover 42 of the housing 40.

Next, the relating structure of the opening and closing operation of the valve 61 is described in detail. The valve 61 is rotatably connected to the body 62 via a hinge. The collecting device 60 further comprises a spring device (which is not shown in the drawings), for urging the valve 61 in a direction to close the valve. Therefore, as shown in part A of FIG. 4, when the collecting device 60 is removed from the housing 40, the valve 61 is closed by the spring device. In addition, the housing 40 is further provided with an ejector pin 422 corresponding to the valve 61 inside the edge of the outlet cover 42. When the collecting device 60 is attached to the outlet cover 42 of the housing 40, the ejector pin 422 forces the corresponding valve 61 to rotate in an opening direction, so that the valve can be opened, and the mosquitoes drawn from the inlet opening 401 can pass through the opened valve 61 and enter into the collecting device 60. When the collecting device 60 is removed from the outlet cover 42 of the housing 40, the spring device urges the valve 61 in a direction to close the valve, so as to prevent the escape of the mosquitoes having been collected within the collecting device 60 from the valve 61.

In this embodiment, the body 62 of the collecting device 60 may be plastic, and the ventilated net 63 may be metal (such as stainless steel), plastic, or the like, and preferably is 250 mesh. If the meshes are too small, resistance thereof to the air flow would be such large that suction force of the air flow would be weak and the meshes would be blocked by the captured mosquitoes or dust easily. If the meshes are too large, the mosquitoes would escape easily. In addition, the combination of the body 62 and the ventilated net 63 also may be replaced with a vent bag.

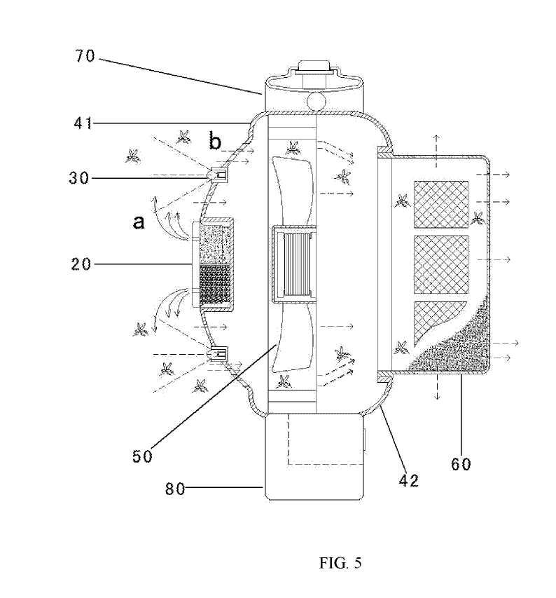

The inset trap 10 according to the first embodiment of the present invention further comprises a light emitting device 30. The light emitting device 30 emits light for attracting the mosquitoes. The position and amount of the light emitting device 30 are not limited, as long as the light emitting device 30 can emit light toward outside of the insect trap 10. However, preferably, the light emitting device 30 is provided to emit toward outside of the inlet end of the insect trap 10, and more preferably, the light emitting device 30 is provided in the vicinity of the inlet opening or adjacent to the inlet opening. As shown in FIG. 1, FIG. 3 and FIG. 5, the light emitting device 30 is provided on the end surface of the inlet cover 41 of the housing 40, so as to attract the mosquitoes to the vicinity of the inlet opening 401.

The light emitting device 30 may be a light emitting diode, a fluorescent lamp or a cold cathode ray tube, and other suitable light emitting devices. Preferably, the light-emitting device is a light emitting diode emitting UV, and more preferably, the wavelength of the UV emitted from the light emitting diode is 385 nm. Since lower power light source not only is attractive to the mosquitoes sufficiently, but also can reduce damage to human eyes and undesired trap of beneficial insects, it is preferable to use a low power light source as the light emitting device 30. For example, the light emitting device 30 may be a light emitting diode with power from 0.01 W to 0.1 W. More preferably, the power of the light emitting diode is 0.06 W. In the first embodiment of the present invention, the light emitting device 30 includes four UV light emitting diodes with the power of 0.06 W and wavelength of 385 nm.

Next, an operating principle of the insect trap 10 according to the first embodiment of the present invention will be described in detail with reference to FIG. 5. FIG. 5 is a schematic view of the insect trap 10 according to the first embodiment of the present invention in an operating state. Before the inset trap 10 starts to operate, the attractant shall be put into the cavity of the attractant holder.

As shown in FIG. 5, after attaching the attractant holder containing the attractant to the housing and starts the inset trap 10, the light emitting device 30 emits light outwardly, and the fan device 50 runs and generates an air flow which passes through the housing from the inlet opening to the outlet opening as shown by the dotted arrows b. In addition, as shown by the solid arrows a, the attractant holder 20 emits volatiles of attractant outwardly via the openings thereof. Since the openings of the attractant holder 20 is located in the vicinity of the inlet opening, and on the upstream of the inlet opening in the b direction of the air flow, the volatiles of attractant, of which the concentration is sufficient to attract mosquitoes, are generated in the vicinity of openings of the attractant holder 20 (that is, in the vicinity of the upstream of inlet opening). A part of the volatiles of attractant subsequently pass through the housing from the inlet opening to the outlet opening along with the air flow b. However, the concentration of the volatiles of attractant is significantly reduced from downstream of the inlet opening to the outlet opening due to the dilution caused by the air flow b. Therefore, the mosquitoes are easily attracted by the volatiles of attractant and the light, and fly to the vicinity of the inlet opening 401. The air flow generated by the fan device 50 draws the mosquitoes attracted to the vicinity of the inlet opening 401 into the housing 40. Then, the drawn mosquitoes along with the air flow pass through the outlet opening 402 and the opened valve 61, and enter into the collecting device 60. The air flow exits the collecting device 60 via the ventilated net 63, while the mosquitoes are trapped within the collecting device 60. Meanwhile, due to the air flow generated by the fan device 50, it is difficult for the mosquitoes to fly out from the collecting device 60 against the air flow.

It should be note that, in the present embodiment, the attractant holder 20 is mounted on the center of the end surface of the inlet cover 41 of the housing 40, and center of the fan device 50 is aligned with center of the end surface of the inlet cover 41. In addition, the end surface is formed into annular grilles, forming a plurality of openings which are used as the inlet opening 401. In this case, the pressure directly in front of the attractant holder 20 is relatively small, and thus a negative pressure caused by the fan device 50 is generated around the attractant holder 20. Such pressure distribution contributes to appropriately increase the volatilization of the attractant in the attractant holder 20, and also can extend the residence time of the volatiles of attractant remaining near the openings of the attractant holder 20, and thus, the concentration of the volatiles of attractant near the openings of the attractant holder 20 can be increased. As a result, the capture efficiency of the mosquitoes can be further improved.

In addition, the aperture and number of the openings of the attractant holder 20 may be set depending on the volatility of various attractants, to control the rate of various attractants running out of the openings. Preferably, the volatiles of attractant run out of the openings at the rate between 0.1 mg/hour and 10 mg/hour. Further, the attractant may evaporate spontaneously at room temperature, and suitable volatility may be reached by controlling the temperature via heating apparatus.

In addition, in the present embodiment, the air flow generated by the fan device 50 may be appropriately controlled, and the specification of the fan device 50 may be determined depending on the requirements on the air flow. The air flow generated by the fan device 50 shall be strong enough to draw the mosquitoes that attracted to the vicinity of the inlet opening by the attractant and light, into the housing, and also shall be weak enough so that the mosquitoes having been attracted to the vicinity of the inlet opening would not feel a turbulence and fly away from the inlet opening. Further, the air flow generated by the fan device 50 shall ensure that the mosquitoes having entered into the collecting device 60 would not fly away from the collecting device 60 against the air flow. Depending on such requirements, the insect trap 10 according to the first embodiment of the present invention may be a six-inch fan of 12V, 200 μA and 2000 r/min. Fan device of other specifications also can be used, as long as the air flow generated by the air flow can meet the above requirements.

### The Second Embodiment

FIG. 7 shows an insect trap according to the second embodiment of the present invention. The second embodiment mainly differs from the first embodiment in positions of the inlet opening and the attractant holder. As shown in FIG. 7, the insect trap according to the second embodiment is in a vertical layout, in which a housing 400 is formed as a hollow cylinder, and a fan device 500 is provided in the hollow portion of the cylinder. The housing 400 has an inlet opening on one end (referred as “an inlet end” hereinafter) and has an outlet opening on the other end. The housing 400 supports an end cap 900 on the inlet end via a plurality of struts 800, and thus the inlet openings are formed by the space between the struts 800. A light emitting device 300 is suspended on the bottom of the end cap 900.

In A-D of FIG. 7, various available arrangements of the attractant holder 200 are shown. For example, as shown in part A of FIG. 7, the attractant holders 200 are disposed on the outside of the end cap 900, and the openings thereof are provided toward the outside of the end cap 900. As shown in part B of FIG. 7, the attractant holders 200 are disposed on the bottom of the end cap 900. As shown in part C of FIG. 7, the attractant holders 200 are disposed on a surface of the housing 400 opposite to the end cap 900. As shown in part D of FIG. 7, the attractant holders 200 are disposed on a side surface of the housing 400. In conclusion, according to the present invention, the attractant holders can be disposed at various locations of the housing, as long as the openings of the attractant holders are located at the upstream of the inlet opening along the flowing direction of the air flow and oriented toward the outside of the housing, in the vicinity of the inlet opening.

### Other Embodiments

The insect traps according to the first and second embodiments of the present invention are described in detail in the above contents. However, the present invention also has other embodiments.

In the forgoing embodiments, the housing 40 is a cylinder with a substantially circular cross section. However, the cross section of the housing may be in other shapes, such as square, polygonal or other irregular shapes.

In the forgoing embodiments, the inlet opening is formed at one end of the housing, and the outlet opening is formed at the other end thereof. However, the inlet and/or outlet opening may be formed at other positions of the housing, such as on a side surface in the middle of the housing, as long as the position and orientation of the inlet and outlet openings causes no turbulence near the inlet opening. It can be expected that, since the present invention employs an influx design, in which the air flow passes through the housing from the inlet opening to the outlet opening, the air flow exiting from the outlet opening would cause a turbulence disturbing the insect at the inlet opening merely in the case that the inlet opening directly faces or immediately closes to the outlet opening.

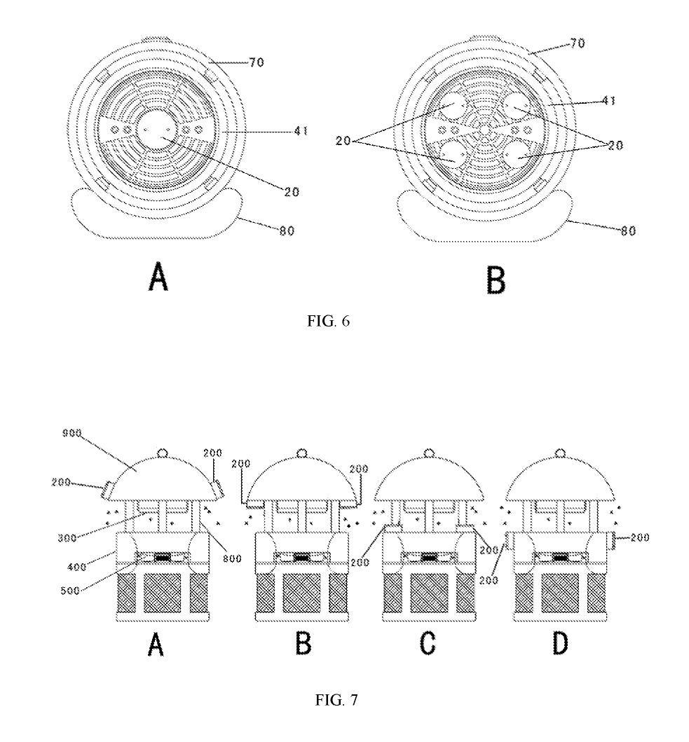

In the insect trap 10 according to the first embodiment of the present invention, as shown in part A of FIG. 6, the attractant holder is single and disposed at the center of the end surface of the inlet end of the housing. However, the position and number of the attractant holders are not limited, as long as the openings of the attractant holders are located at the upstream of the inlet opening along the flowing direction of the air flow and oriented toward the outside of the housing, in the vicinity of the inlet opening. For example, in the first embodiment of the present invention, as shown in part B of FIG. 6, the insect trap may comprises a plurality of the attractant holders, which may be disposed equidistantly on the end surface of the inlet end of the housing. The insect trap according to the embodiment as shown in FIG. 7 also may comprise a plurality of attractant holders.

Further, according to the first embodiment of the present invention, the end surface of the inlet end of the housing is formed as annular grilles, and the openings between the grilles are formed as the inlet opening. However, the end surface of the inlet end of the housing also may be formed into other suitable shapes and structures.

Further, according to the first embodiment of the present invention, the attractant holder is detachably mounted to the housing via the structure of tenon and mortise. However, the attractant holder also may be detachably mounted to the housing via other suitable connecting structures, such as a buckle, magnetic connection and friction connection. Further, the attractant holder may be fixed to the housing and the attractant may be added to the cavity via an opening or a cover which can be opened.

Further, according to the first embodiment of the present invention, the collecting device is detachably attached to the housing via the structure of slot and tenon. However, the collecting device also may be detachably attached to the housing via other suitable connecting structures, such as a buckle, magnetic connection and friction connection. Further, the collecting device achieves the automatic opening and closing of the valve via an ejector pin and a spring. However, the present invention may use other means to achieve the automatic opening and closing of the valve via other suitable means, such as mechanical structure such as a cam groove structure, or electromagnetic structure.

Further, in the forgoing embodiment, the insect trap includes a light emitting device. However, the light emitting device may be not included according to actual requirements. Alternatively, the light emitting device may be provided with a switch.

Further, in the above contents, the present invention is described by taking the mosquitoes as an example. However, the insect trap of the present invention also can be used to trap other types of insects, such as a drosophila, by changing the kind of attractant, the wavelength of light emitted by the light emitting device and the mesh size of the collecting device. The attractant for the drosophila commonly used in the art includes banana, red bayberry, and sweet and sour. For example, the Chinese Patent Application Publication No. CN102805110A discloses an attractant for the drosophila and the preparation method thereof.

### Technical Effects

In the above contents, the structures and functions of the insect trap according to the embodiment of the present invention are described in detail. The insect trap of the present invention has the following advantages.

In the insect trap according to the embodiment of the present invention, the fan device generates an air flow passing through the housing from the inlet opening to the outlet opening, to draw in the mosquitoes from the inlet opening. Since the insect trap of the present invention generates the air flow merely in a single direction at the inlet opening, thus it can trap the mosquitoes with a simpler structure and also avoid turbulence, and can easily meet the requirements to the concentration of volatiles of attractant for attracting mosquitoes. Further, in the insect trap of the present invention, the openings of the attractant holders are disposed near the inlet opening of the housing, and located at the upstream of the inlet opening along the flowing direction of the air flow and oriented toward the outside of the housing. With such a configuration, the concentration of the volatiles of attractant is highest in the vicinity of the inlet opening. Although part of the volatiles enter into the inlet opening and flow toward the outlet opening in the downstream along with the air flow, these volatiles are rapidly diluted by the air flow. As a result, compared to the outlet opening, the mosquitoes are more likely to be attracted by the volatiles near the inlet opening, and thus the structure of the present invention can significantly improve the trapping efficiency of mosquitoes.

Further, in the preferred embodiment of the present invention, the attractant holder is disposed on the end surface of the inlet end of the housing, the end surface is formed with grilles, and the center of the end surface is aligned with the center of the fan device. In this case, the pressure directly in front of the attractant holders is relative small, and thus a negative pressure is generated around the attractant holder due to the air flow generated by the fan device. This pressure distribution contributes to appropriately increase the volatilization of the attractant in the attractant holder, and can also extend the residence time of the volatiles of attractant remaining near the openings of the attractant holder. Thus, the concentration of the volatiles of attractant near the openings of the attractant holder (that is, near the upstream of the inlet opening) can be increased.

Further, the collecting device of the insect trap of the present invention includes a valve. The valve is opened when the collecting device is attached to the housing, so that the mosquitoes drawn into the inlet opening can enter into the collecting device, and the valve is closed when the collecting device is removed from the housing, so as to prevent the mosquitoes from escaping from the collecting device.

Therefore, the insect trap according to the embodiment of the present invention has the advantages of simple structure, small size, and low manufacturing cost. Also, the insect trap uses non-toxic attractant without pollution to the environment and thus is environmentally friendly. Moreover, the insect trap of the present invention is suitable for indoor use.

Next, the effects of capturing mosquitoes of the insect trap according to the present invention will be shown by two experiments.

### The First Experiment

The experiment is performed by comparing the insect trap shown in part A of FIG. 6 according to the first embodiment of the present invention with an insect trap as Comparative Example 1, and comparing the insect trap shown in part D of FIG. 7 according to the second embodiment of the present invention with an insect trap as Comparative Example 2; wherein the Comparative Example 1 is an insect trap as shown in FIG. 6 with the attractant holder removed, and the Comparative Example 2 is an insect trap of Mosquito Talent of second generation commercially available from Taiwan Green House, without an attractant holder as shown in the present invention. In addition, the insect trap as shown in FIG. 6 and the Comparative Example 1 use the light-emitting diode as the light emitting device, and the insect trap as shown in D of FIG. 7 and the Comparative Example 2 use the cold cathode ray tube as the light emitting device. Since the light emitting devices in the two groups of insect traps differ from each other in power, the two groups of insect traps are positioned at different places to avoid interference with each other.

In Guangdong area of China, the average temperature is from 23□ to 30□ in May, and from 25° C. to 31° C. in rainy June. The activities of the mosquitoes start in March, reach a peak in May, and decrease and even into not disturbing humans in July and August when the high temperature is above 35° C. Therefore, during May to June of a year when the mosquitoes are active, a comparative experiment is performed for a long period of continuous 24 hours in a factory in Guangdong where the amount of mosquitoes is large. The experimental sites are an electrical room with a smaller area of 18 square meters and a workshop with a bigger area of 210 square meters in the factory, and both the two experimental sites have no anti-mosquito screens.

In the first period of the experiment from May 9 to May 31, one insect trap of the first embodiment shown in part A of FIG. 6 and one insect trap as the Comparative Example 1 are placed in the electrical room at the same time, and one insect trap of the second embodiment shown in part A of FIG. 7 and one insect trap as the Comparative Example 2 are put in the workshop with larger area at the same time. The distance between the two insect traps in the same group is 1.5 m. In the second period of the experiment from June 1 to June 27, the positions of the two groups of insect traps are exchanged.

The number of mosquitoes captured by each of the insect traps in the two groups is counted, and the results are shown in Table 1.

TABLE 1
Comparison of the Number of Mosquitoes Captured by the Insect
Trap of the Present Invention with that of Comparative Examples

| | First | Comparative | | Second | Comparative | |
|---|---|---|---|---|---|---|
| | Embodiment | Example 1 | | Embodiment | Example 2 | |
| | (Total Number | (Total Number | Improvement | (Total Number | (Total Number | Improvement |
| Experimental | of Captured | of Captured | of Trapping | of Captured | of Captured | of Trapping |
| Time | Mosquitoes) | Mosquitoes) | Efficiency | Mosquitoes) | Mosquitoes) | Efficiency |
| | Electrical Room | Electrical Room | | Workshop | Workshop | |
| From May 9 | 534 | 349 | 53% | 1,717 | 1,277 | 34% |
| to May 31 | | | | | | |
| | Workshop | Workshop | | Electrical Room | Electrical Room | |
| From June 1 | 811 | 577 | 41% | 228 | 157 | 45% |
| to June 27 | | | | | | |

As can be seen from the experimental results in Table 1, compared to the Comparative Example 1, the insect trap according to the first embodiment shown in part A of FIG. 6 improves the trapping efficiency by 53% in the electrical room with a smaller area, and by 41% in the workshop with a larger area in the same period of time. Similarly, compared to the Comparative Example 2, the insect trap according to the second embodiment shown in part D of FIG. 7 improves the trapping efficiency by 45% in the electrical room with a smaller area, and by 34% in the workshop with a larger area.

As can be seen, the trapping efficiency of the insect trap, which attracts mosquitoes by both the attractant holder and the light emitting device at the same time, is much higher compared to the insect trap without attractant holder and attracting mosquitoes merely by the light emitting device. It should be noted that, the trapping efficiency of the same insect trap in the electrical room with a smaller area is about 10% higher than that in the workshop with a larger area. The difference mainly relates to the higher concentration of the volatiles in the small space.

### The Second Experiment

The experiment is performed by comparing the insect trap shown in part A of FIG. 6 according to the first embodiment of the present invention with the insect traps as Comparative Example 3 and Comparative Example 4; wherein the Comparative Example 3 is an insect trap shown in part A of FIG. 6 with the attractant holder disposed in the nets of the collecting device, and the Comparative Example 4 is an insect trap shown in part A of FIG. 6 with the attractant holder removed and other configuration unchanged. From August 30 to September 19, the comparative experiment is performed in the workshop for a long time period of continuous 24 hours, and the windows of the experimental sites have no anti-mosquito screens. At this time, since the ambient temperature is from 23° C. to 33° C. and it has been entered September, the mosquitoes are less.

One insect trap of the first embodiment shown in part A of FIG. 6, one insect trap as the Comparative Example 3, and one insect trap as the Comparative Example 4 are put in the workshop at the same time, and the distance between the insect traps is 1.5 m.

The number of mosquitoes captured by each insect trap is counted after the experiment, and the results are shown in Table 2.

TABLE 2
Comparison of the Number of Mosquitoes Captured by the Insect Trap of the Present Invention
with that of Comparative Examples

| | | | | Improvement | Improvement |
|---|---|---|---|---|---|
| | | | | of Trapping | of Trapping |
| | | | | Efficiency of | Efficiency of |
| | First | Comparative | Comparative | the first | the first |
| | Embodiment | Example 3 | Example 4 | Embodiment | Embodiment |
| | (Total Number | (Total Number | (Total Number | Compared with | Compared with |
| Experimental | of Captured | of Captured | of Captured | Comparative | Comparative |
| Time | Mosquitoes) | Mosquitoes) | Mosquitoes) | Example 3 | Example 4 |
| From August | 86 | 38 | 32 | 126% | 169% |
| 30 to | | | | | |
| September 19 | | | | | |

It can be seen from the experimental results in Table 2 that, compared to the Comparative Example 3, the insect trap of the first embodiment shown in part A of FIG. 6 in the same workshop improves the trapping efficiency by 126% in the same period of time. Meanwhile, compared to the Comparative Example 4 without attractant holder, the insect trap according to the first embodiment with the attractant holder also significantly improves the trapping efficiency.

It can thus be seen that, compared to the insect trap with the attractant holder disposed away from the inlet opening (such as closer to the inlet opening), the trapping efficiency of the insect trap with the attractant holder disposed near the inlet opening, is much higher. It should be noted that, the total number of the mosquitoes captured by the insect traps is not very large in the experiment, since the number of mosquitoes decreases during the experiment (in September).

Although the embodiments of the present invention have been described in detail hereinbefore, the present invention is not limited to the above embodiments or configurations, and any various modifications and substitutions can be made to the above embodiments without departing from the scope of the present invention.

1.-30. (canceled)

31. An insect trap, comprising:
a housing including an inlet opening and an outlet opening;
a fan device disposed within the housing, for generating an air flow passing through the housing from the inlet opening to the outlet opening to draw in insects from the inlet opening;
a collecting device attached to the outlet opening of the housing, so as to collect the insects being drawn into the housing; and
an attractant holder including at least one cavity for disposing an attractant and an opening for emitting volatiles of the attractant,
wherein the attractant holder is disposed so that the opening of the attractant holder is in the vicinity of the inlet opening, and is located upstream of the inlet opening along an flowing direction of the air flow and is oriented toward outside of the housing, and
the collecting device is detachably mounted to the housing,
the collecting device includes a valve, the valve is opened when the collecting device is mounted to the housing, so that the insects drawn in through the inlet opening can pass through the valve and enter into the collecting device, and the valve is closed when the collecting device is removed from the housing, so as to prevent insects inside the collecting device from getting away from the collecting device through the valve.

32. The insect trap according to claim 31, wherein
the housing is formed as a hollow cylinder, the fan device is provided within a hollow portion of the cylinder, the inlet and the outlet openings are communicated with the hollow portion, and the position and orientation of the inlet and outlet openings are provided so that the air flow discharged from the outlet opening causes no turbulence near the inlet opening.

33. The insect trap according to claim 32, wherein
the inlet opening is located at one end of the cylinder, and the outlet opening is located at the other end of the cylinder.

34. The insect trap according to claim 33, wherein
the inlet opening is provided on an end surface at the one end of the cylinder.

35. The insect trap according to claim 34, wherein
the housing further comprises an inlet cover which is formed as the one end of the cylinder, and the inlet cover comprises at least one opening for forming the inlet opening.

36. The insect trap according to claim 33, wherein
the inlet opening is provided on a side surface at the one end of the cylinder.

37. The insect trap according to claim 31, wherein
the attractant holder is detachably mounted to the housing.

38. The insect trap according to claim 31, wherein
the attractant holder is provided adjacent the inlet opening.

39. The insect trap according to claim 31, wherein
the attractant holder is mounted within the housing.

40. The insect trap according to claim 33, wherein
the attractant holder is mounted to an end surface at the one end of the cylinder.

41. The insect trap according to claim 40, wherein
the attractant holder is mounted to a center of the end surface at the one end of the cylinder.

42. The insect trap according to claim 41, further comprising
a plurality of said attractant holders.

43. The insect trap according to claim 42, wherein
the plurality of the attractant holders are arranged equidistantly.

44. The insect trap according to claim 35, wherein
an end surface of the inlet opening is formed with grilles so as to form the inlet opening, and the attractant holder is mounted to a center of the end surface which is aligned with a center of the fan device.

45. The insect trap according to claim 31, wherein
the collecting device is a ventilate bag or a box including a ventilated net.

46. The insect trap according to the claim 31, wherein
the housing comprises an ejector pin,
the collecting device further comprises a spring device, the valve is rotatably connected to the collecting device via a hinge, and the spring device urges the valve in a direction to close the valve,
the ejector pin forces the valve to rotate in the opening direction when the collecting device is being mounted to the housing.

47. The insect trap according to claim 31, wherein
the attractant is one of or a combination of at least two of: pheromone, lactic acid, agorophyl alcohol, compound that can be decomposed to release ammonia gas, and compound that can be decomposed to release carbon dioxide.

48. The insect trap according to the claim 47, wherein
the compound that can be decomposed to release ammonia gas comprises ammonium bicarbonate.

49. The insect trap according to the claim 47, wherein
the compound that can be decomposed to release carbon dioxide comprises ammonium bicarbonate.

50. The insect trap according to claim 31, wherein
the aperture of the opening of the attractant holder is arranged so that the volatiles of the attractant run out of the openings at the rate between 0.1 mg/hour and 10 mg/hour.

51. The insect trap according to claim 31, further comprising
a light emitting device for emitting lights attracting insects.

52. The insect trap according to the claim 51, wherein
the light emitting device is at least one of a light emitting diode, a fluorescent lamp or a cold cathode ray tube.

53. The insect trap according to the claim 51, wherein
the light emitting device is a light emitting diode emitting UV.

54. The insect trap according to the claim 53, wherein
the power of the light emitting diode is in the range of 0.01 w to 1 w.

55. The insect trap according to claim 31, further comprising
a plurality of said light emitting diodes.
